(19) United States
(12) Patent Application Publication
(10) Pub. No.: US 2026/0363839 A1
(43) Pub. Date: Nov. 19, 2026

(54) BODY STRUCTURE OF HANDHELD APPLIANCE, AND HANDHELD APPLIANCE

(71) Applicant: SHENZHEN SHUYE TECHNOLOGY CO., LTD., Shenzhen (CN)

(72) Inventor: Hongxin YE, Shenzhen (CN)

(73) Assignee: SHENZHEN SHUYE TECHNOLOGY CO., LTD., Shenzhen (CN)

(21) Appl. No.: 19/737,338

(22) Filed: Jul. 10, 2026

Related U.S. Application Data
(63) Continuation of application No. PCT/CN2024/086807, filed on Apr. 9, 2024.

(30) Foreign Application Priority Data
Jan. 12, 2024 (CN) 202420089921.9

(51) Int. Cl. A61C 17/22

(52) U.S. Cl. CPC A61C 17/225

(57) ABSTRACT

A body structure of a handheld appliance and the handheld appliance are provided. The body structure of the handheld appliance includes a housing, an input assembly, and a motor bracket. The housing has a cylindrical shape and defines a mounting cavity. The housing is provided with a through hole at one end of the housing. The through hole is in communication with the mounting cavity. The housing is provided with a pressing region and an inadvertent-press region on an outer peripheral wall of the housing adjacent to the through hole, and the inadvertent-press region is located around the pressing region. The input assembly includes a main control board and a flexible pad that are both mounted in the mounting cavity. The main control board is provided with an input button at a position opposite to the pressing region.

### CROSS-REFERENCE TO RELATED APPLICATIONS

This application is a continuation of International Application No. PCT/CN 2024/086807, filed Apr. 9, 2024, which claims priority to Chinese Patent Application No. 202420089921.9, filed Jan. 12, 2024, the entire disclosures of both of which are incorporated herein by reference.

### FIELD

The disclosure relates to the field of handheld appliance technology, and in particular, to a body structure of a handheld appliance and the handheld appliance.

### BACKGROUND

An existing handheld appliance (such as an electric toothbrush and an electric shaver) is generally not provided with any through hole on an outer circumferential surface of a handle housing to achieve full waterproofing. Alternatively, if a hole is defined on the outer circumferential surface of the handle housing, the hole will be filled without mounting a button cover. Accordingly, an internal button inside the handle housing can only be actuated via integral deformation of the handle housing.

The handle housing of the existing handheld appliance is provided with a pressing region opposite to the internal button to allow a user to actuate the button by pressing the pressing region. Nevertheless, since the handle housing is of an integral structure, when the user presses a region surrounding the pressing region, the pressing region may be driven to deform, causing the button to be triggered, which in turn leads to false triggering of the handheld appliance. Therefore, there is an urgent need to solve this problem.

### SUMMARY

A main objective of the disclosure is to provide a body structure of a handheld appliance to solve the problem of false triggering that may occur in handheld appliances in the related art.

To achieve the above objective, the disclosure provides a body structure of a handheld appliance, including a housing, an input assembly, and a motor bracket. The housing has a cylindrical shape and defines a mounting cavity. The housing is provided with a through hole at one end of the housing. The through hole is in communication with the mounting cavity. The housing is provided with a pressing region and an inadvertent-press region on an outer peripheral wall of the housing adjacent to the through hole, and the inadvertent-press region is located around the pressing region. The input assembly includes a main control board and a flexible pad that are both mounted in the mounting cavity. The main control board is provided with an input button at a position opposite to the pressing region, and the flexible pad is mounted between the pressing region and the input button. The motor bracket is disposed in the mounting cavity. The motor bracket abuts against a side of the main control board facing away from the flexible pad. The motor bracket is provided with a supporting boss at a position opposite to the inadvertent-press region, and the supporting boss is configured to support the inadvertent-press region.

The present disclosure further provides a handheld appliance, including a head and the body structure of the handheld appliance as described above. The head is mated with the body structure of the handheld appliance.

### BRIEF DESCRIPTION OF THE DRAWINGS

In order to more clearly illustrate the technical solutions in the embodiments of the disclosure, the drawings to be used in the illustration of the embodiments will be briefly introduced below. Obviously, the drawings described below are only some embodiments of the disclosure, and for those skilled in the art, other drawings can be obtained based on these drawings without creative efforts.

FIG. 1 is a schematic structural view of a body structure of a handheld appliance according to an embodiment of the present disclosure.

FIG. 2 is a cross-sectional view of FIG. 1, taken along line A-A.

FIG. 3 is a schematic structural view of a housing in FIG. 2.

FIG. 4 is an exploded view of an input assembly in FIG. 2.

FIG. 5 is a schematic structural view of a motor bracket in FIG. 2.

FIG. 6 is a schematic enlarged view of region D in FIG. 2.

FIG. 7 is a cross-sectional view of FIG. 1, taken along line B-B.

FIG. 8 is a cross-sectional view of the housing in FIG. 3.

FIG. 9 is a schematic structural view of the motor bracket in FIG. 2, viewed from another direction.

FIG. 10 is a cross-sectional view of FIG. 1, taken along line C-C.

FIG. 11 is a schematic assembly view of the motor bracket and the main control board in FIG. 2.

FIG. 12 is a cross-sectional view of FIG. 5, taken along line E-E.

### REFERENCE SIGNS

100 body structure; 110 housing; 111 mounting cavity; 112 through hole; 113 pressing region; 114 inadvertent-press region; 115 fitting groove; 120 input assembly; 121 main control board; 1211 input button; 122 flexible pad; 130 motor bracket; 131 supporting boss; 132 first rib; 133 second rib; 134 third rib; 135 fitting rib; 138 fourth rib; 1351 fitting segment; 1352 connecting segment; 136 supporting structure; 1361 first supporting block; 1362 second supporting block; 1363 retaining hook portion; 137 mounting flat surface.

The realization of the objective, functional features, and advantages of the present disclosure will be further described in conjunction with the embodiments and with reference to the accompanying drawings.

### DETAILED DESCRIPTION OF EMBODIMENTS

The technical solutions in the embodiments of the disclosure will be described clearly and completely below in conjunction with the accompanying drawings in the embodiments of the disclosure. Obviously, the described embodiments are only a part of the embodiments of the disclosure, rather than all the embodiments. Based on the embodiments in the disclosure, all other embodiments obtained by a person of ordinary skill in the art without creative efforts fall within the protection scope of the disclosure.

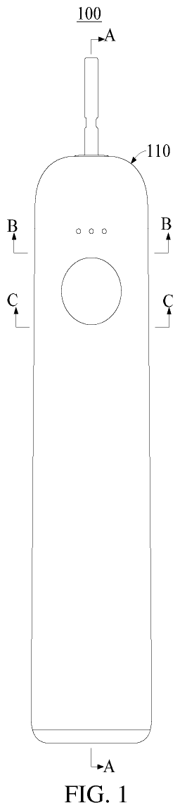

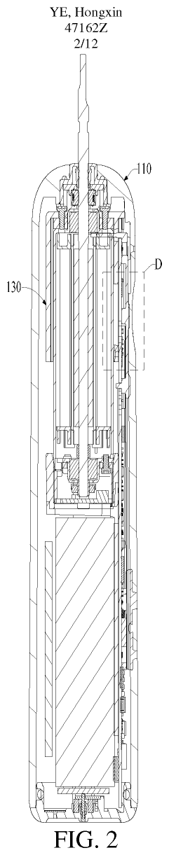

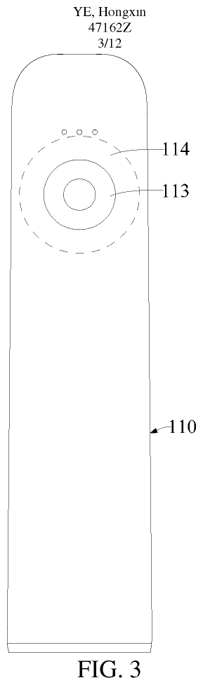

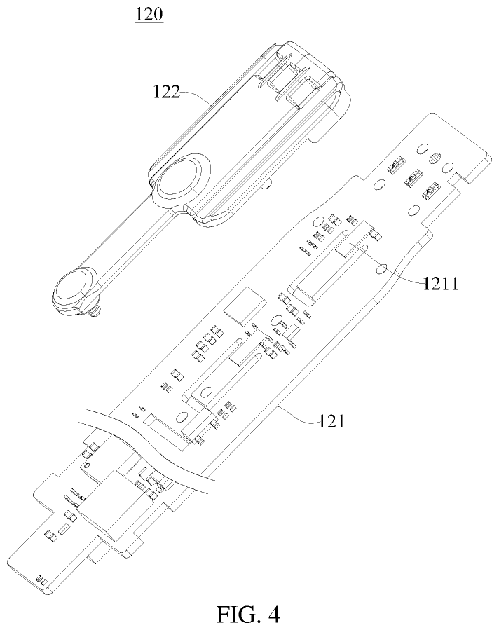

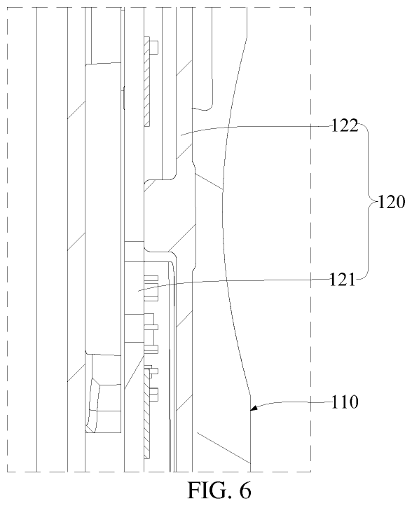

Referring to FIG. 1 to FIG. 7, the present disclosure provides a body structure 100 of a handheld appliance. The body structure 100 includes a housing 110, an input assembly 120, and a motor bracket 130. The housing 110 has a cylindrical shape and defines a mounting cavity 111. The housing 110 is provided with a through hole 112 at one end of the housing 110. The through hole 112 is in communication with the mounting cavity 111. The housing 110 is provided with a pressing region 113 and an inadvertent-press region 114 on an outer peripheral wall of the housing 110 adjacent to the through hole 112, and the inadvertent-press region 114 is located around the pressing region 113. The input assembly 120 includes a main control board 121 and a flexible pad 122 that are both mounted in the mounting cavity 111. The main control board 121 is provided with an input button 1211 at a position opposite to the pressing region 113, and the flexible pad 122 is mounted between the pressing region 113 and the input button 1211. The motor bracket 130 is disposed in the mounting cavity 111 and abuts against a side of the main control board 121 facing away from the flexible pad 122. The motor bracket 130 is provided with a supporting boss 131 at a position opposite to the inadvertent-press region 114, and the supporting boss 131 is configured to support the inadvertent-press region 114.

The housing 110 has a cylindrical shape, and the shape of the cross section of the housing 110 may vary. For example, the cross section of the housing 110 may be circular, elliptical, square, regular polygonal, etc., which is not specifically limited here. The mounting cavity 111 inside the housing 110 is configured for mounting of structural members such as the input assembly 120, the motor bracket 130, and a motor. Therefore, one end of the housing 110 is usually open-ended, so that the structural members such as the input assembly 120, the motor bracket 130, and the motor can be mounted in the mounting cavity 111. The other end of the housing 110 is further provided with the through hole 112 that penetrates through the housing 110. The through hole 112 is in communication with the mounting cavity 111, so as to allow a driving shaft that is drivingly connected to the motor to extend therethrough.

When subjected to an external force, the pressing region 113 on the outer peripheral wall of the housing 110 may slightly deform. That is, the thickness of the pressing region 113 on the housing 110 is less than the thickness of other portions of the housing 110, ensuring that the pressing region 113 can quickly deform after being pressed. The inadvertent-press region 114 on the outer peripheral wall of the housing 110 located around the pressing region 113 may also deform when pressed by an external force. That is to say, when the inadvertent-press region 114 is pressed, the pressing region 113 is driven to deform together, thereby creating a false impression that the pressing region 113 has been pressed, which may result in misoperation.

The input assembly 120 includes the main control board 121 and the flexible pad 122. The main control board 121 is usually strip-shaped, and is disposed in the mounting cavity 111 in an extension direction of the mounting cavity 111. The main control board 121 is provided with the input button 1211 at a position opposite to the pressing region 113. The input button 1211 may be a mechanical button, a micro switch, a pressure sensor, etc. The flexible pad 122 may be made of rubber or silicone. The flexible pad 122 is disposed between the pressing region 113 and the input button 1211. When the flexible pad 122 is assembled between the pressing region 113 and the input button 1211, the flexible pad 122 is squeezed. That is, the flexible pad 122 elastically abuts against both the pressing region 113 and the input button 1211. In this way, the gap between the pressing region 113 and the input button 1211 may be eliminated by the flexible pad 122, so as to improve the sensitivity of the input button 1211.

The motor bracket 130 may have a cylindrical shape, or may be ring-shaped with an open side. In this case, the cross section of the motor bracket 130 is ring-shaped with an opening. The motor bracket 130 may be in other shapes, which is not specifically limited here. The motor bracket 130 is fixedly mounted in the mounting cavity 111. The motor bracket 130 abuts against the main control board 121, that is, the main control board 121 can be fixed on the outer peripheral wall of the motor bracket 130. The supporting boss 131 disposed on the motor bracket 130 at a position opposite to the inadvertent-press region 114 may be block-shaped or strip-shaped, which is not limited here. The supporting boss 131 is configured to abut against the inadvertent-press region 114, so as to restrict deformation of the inadvertent-press region 114 when pressed by an external force.

In the present disclosure, the pressing region 113 is provided on the housing 110 at a position opposite to the input button 1211. When the pressing region 113 is pressed, the pressing region 113 deforms and abuts against the flexible pad 122 to trigger the input button 1211, thereby achieving input of a control instruction. The supporting boss 131 is provided on the motor bracket 130 at a position opposite to the inadvertent-press region 114 of the housing 110. The supporting boss 131 is configured to abut against the inadvertent-press region 114 of the housing 110, so that the amount of deformation generated in the inadvertent-press region 114 can be limited to be relatively small or even zero, thereby preventing false triggering of the input button 1211 that would otherwise result from deformation of the pressing region 113 driven by pressing the inadvertent-press region 114.

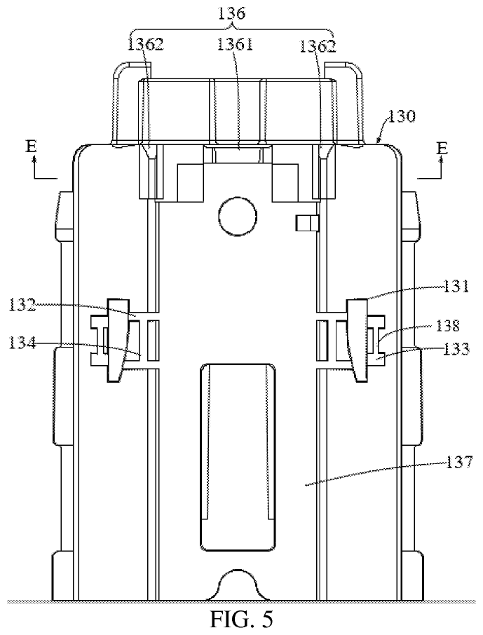

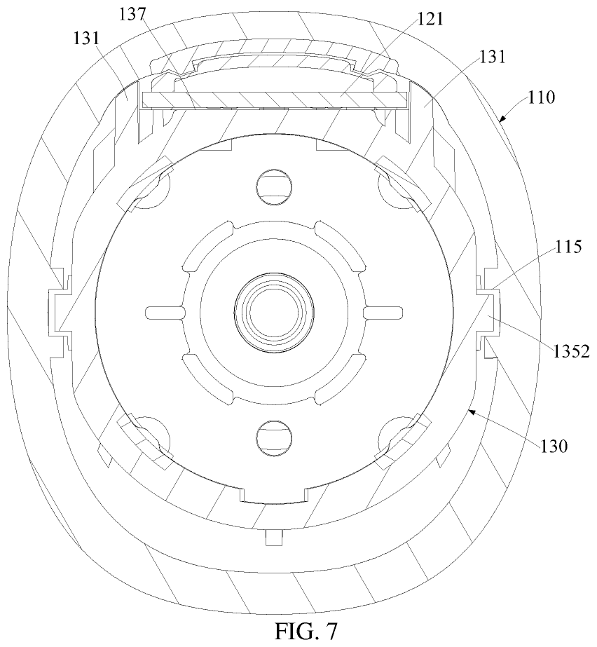

In some embodiments of the present disclosure, the supporting boss 131 is implemented as at least two supporting bosses 131. That is, the number of the supporting bosses 131 may be two, three, four, or even more. The at least two supporting bosses 131 are respectively disposed on two opposite sides of the main control board 121 in a circumferential direction of the motor bracket 130. Specifically, referring to FIG. 5 and FIG. 7, in an embodiment of the present disclosure, the number of the supporting bosses 131 is two. The two supporting bosses 131 are respectively located on two opposite sides of the main control board 121 in the circumferential direction of the motor bracket 130. The two supporting bosses 131 respectively abut against the inadvertent-press region 114, so that two opposite positions of the inadvertent-press region 114 can be supported, which helps to ensure overall force balance of the sensitive trigger region. In this way, it can be further ensured that the input button 1211 will not be falsely triggered when the inadvertent-press region 114 is pressed. In addition, the two supporting bosses 131 can limit the movement of the main control board 121 in the circumferential direction of the motor bracket 130, thus preventing the main control board 121 from displacing in the circumferential direction of the motor bracket 130.

Referring to FIG. 5, in some embodiments of the present disclosure, the supporting boss 131 extends in an axial direction of the motor bracket 130. The axial direction of the motor bracket 130 is the same as the axial direction of the housing 110. The supporting boss 131 is provided with two first ribs 132 on a side of the supporting boss 131 adjacent to the main control board 121, and is provided with two second ribs 133 on a side of the supporting boss 131 facing away from the main control board 121. The two first ribs 132 and the two second ribs 133 are spaced apart from each other in the axial direction of the motor bracket 130. With such a configuration, the number of supporting positions of the supporting boss 131 in the circumferential direction of the motor bracket 130 is increased, thereby ensuring the connection strength between the supporting boss 131 and the motor bracket 130, and further ensuring that the supporting boss 131 is not easily broken.

Further, the two first ribs 132 are connected to each other by a third rib 134, and the third rib 134 is fixedly connected to the motor bracket 130; and/or, the two second ribs 133 can also be connected to each other by a fourth rib 138, and the fourth rib 138 is fixedly connected to the motor bracket 130. With such a configuration, the connection strength between the two first ribs 132 and the motor bracket 130, and the connection strength between the two second ribs 133 and the motor bracket 130 can be further enhanced. Moreover, with the two first ribs 132, the two second ribs 133, the third rib 134, and the fourth rib 138, the connection area between the supporting boss 131 and the motor bracket 130 is equivalently increased, thus strengthening the connection between the supporting boss 131 and the motor bracket 130.

Based on the above embodiments, it may be noted that, the motor bracket 130 is configured for mounting the motor. One end of the driving shaft of the handheld appliance is drivingly connected to the motor, and the other end of the driving shaft of the handheld appliance passes through the through hole 112 of the housing 110 to be connected to a brush head of the handheld appliance. During operation of the handheld appliance, an external force applied to the head may cause the driving shaft to deflect to one side, which in turn causes one side of the motor bracket 130 to move toward the housing 110. In particular, when the motor bracket 130 pivots toward the pressing region 113, it is also likely to cause false triggering of the input button 1211.

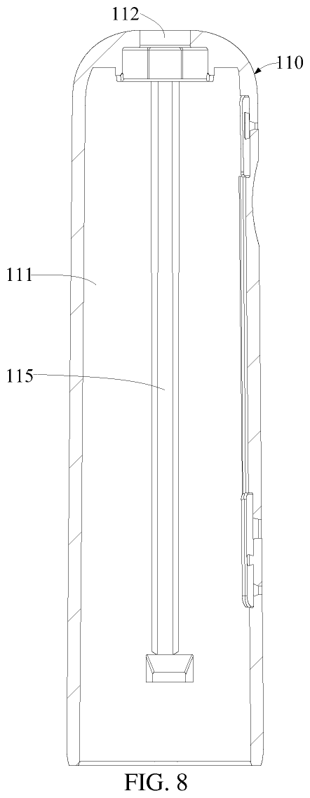

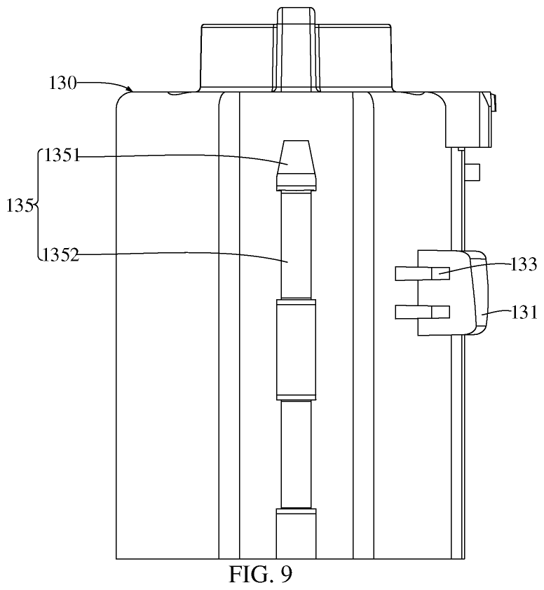

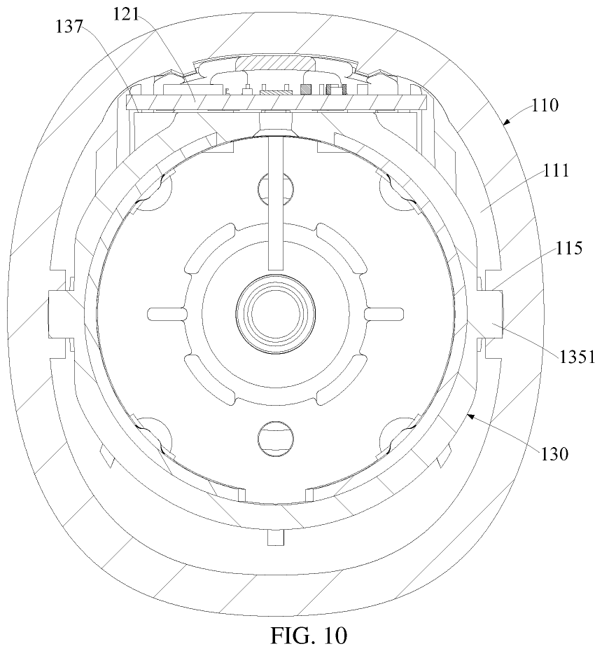

In view of the above problem, referring to FIG. 8 to FIG. 10, in some embodiments of the present disclosure, the mounting cavity 111 is provided with two fitting grooves 115 on a cavity wall of the mounting cavity 111. The two fitting grooves 115 both extend in an axial direction of the housing 110. The two fitting grooves 115 are respectively disposed on two sides of the inadvertent-press region 114 in a circumferential direction of the housing 110. The motor bracket 130 is provided with two fitting ribs 135 on an outer peripheral wall of the motor bracket 130, and each of the two fitting ribs 135 has an interference fit with a corresponding fitting groove 115. With such a configuration, the two fitting ribs 135 are respectively fitted with the two fitting grooves 115, so as to restrict the motor bracket 130 from pivoting relative to the housing 110. In addition, in combination with the technical solution in which the supporting boss 131 abuts against the inadvertent-press region 114, the motor bracket 130 can be restricted from pivoting toward the pressing region 113, thereby avoiding the problem of false triggering of the input button 1211 due to the pivoting of the motor bracket 130.

In some embodiments of the present disclosure, an orthographic projection of each of the two fitting ribs 135 in a direction in which the input assembly 120 faces toward the housing 110 at least partially overlaps with the pressing region 113. That is, at least on a side of each fitting rib 135 adjacent to the motor bracket 130, the orthographic projection of each fitting rib 135 in the direction in which the input assembly 120 faces toward the housing 110 can overlap with the pressing region. In this way, it can be ensured that each fitting rib 135 can provide support when the pressing region 113 is pressed, thereby preventing position deviation of the motor bracket 130 when the pressing region 113 is pressed.

It may be noted that, the positions where the two fitting grooves 115 are disposed may be various. The central angles subtended by the two fitting grooves 115 may be 180 degrees, or 160 degrees, or other angles, which is not limited here. Preferably, the sum of the central angles subtended by the two fitting grooves 115 is 180 degrees, that is, the openings of the two fitting grooves 115 are disposed opposite to each other, and the central angle subtended by each of the two fitting grooves 115 is equal to the central angle subtended by the pressing region 113. In other words, the central angle subtended by each fitting groove 115 and the central angle subtended by the pressing region 113 are both 90 degrees. With such a configuration, the forces on two opposite sides of the motor bracket 130 are balanced. Furthermore, the assembly direction of the two fitting ribs 135 is perpendicular to the pivoting direction of the motor bracket 130, so that the motor bracket 130 can be better constrained.

Further, each fitting rib 135 includes at least two fitting segments 1351 and at least one connecting segment 1352. Each two adjacent fitting segments 1351 are connected by one connecting segment 1352. The fitting segments 1351 of each fitting rib 135 each have an interference fit with a corresponding fitting groove 115, and the connecting segment 1352 of each fitting rib 135 has a clearance fit with a corresponding fitting groove 115. With such a configuration, the area of interference fit between each fitting rib 135 and the corresponding fitting groove 115 can be reduced, which facilitates the fitting between the fitting rib 135 and the corresponding fitting groove 115, and thus facilitates the assembly of the motor bracket 130 with the housing 110.

Still further, in the at least two fitting segments 1351 of each fitting rib 135, the fitting segment 1351 adjacent to the through hole 112 is configured to be wedge-shaped. The end of the fitting rib 135 adjacent to the through hole 112 may be formed by the fitting segment 1351, or may be formed by the connecting segment 1352, which is not specifically limited here. The width of the fitting segment 1351 adjacent to the through hole 112 gradually decreases in a direction toward the through hole 112. In this way, the fitting segment 1351 adjacent to the through hole 112 can be more easily inserted into the corresponding fitting groove 115, which further facilitates sliding of the entire fitting rib 135 relative to the corresponding fitting groove 115 until the fitting rib 135 is assembled in place.

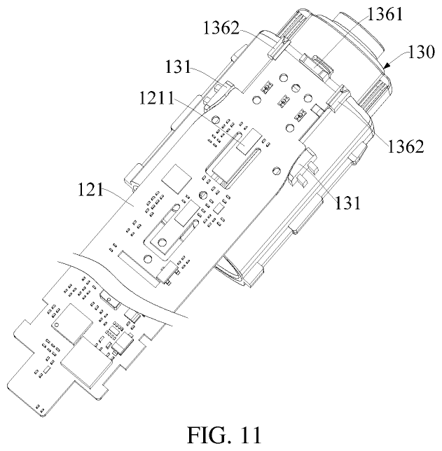

Referring to FIG. 5 and FIG. 11, in some embodiments of the present disclosure, the motor bracket 130 is further provided with a supporting structure 136 on an outer peripheral wall of the motor bracket 130 facing the pressing region 113. The supporting structure 136 and the supporting boss 131 are spaced apart from each other in the axial direction of the motor bracket 130, and the supporting structure 136 is configured to abut against a portion of the housing 110 located between the through hole 112 and the inadvertent-press region 114. With such a configuration, a side of the motor bracket 130 facing the pressing region 113 is positioned and limited by the supporting boss 131 and the supporting structure 136, and the supporting structure 136 is disposed adjacent to the through hole 112, which makes it more difficult for the motor bracket 130 to pivot toward the pressing region 113. Consequently, this ensures that the input button 1211 will not be falsely triggered due to the pivoting of the motor bracket 130.

Specifically, the supporting structure 136 includes a first supporting block 1361. The first supporting block 1361 is disposed on the outer peripheral wall of the motor bracket 130 facing the pressing region 113. The first supporting block 1361 extends in a circumferential direction of the motor bracket 130. The first supporting block 1361 is configured to abut against the portion of the housing 110 located between the through hole 112 and the inadvertent-press region 114, and the first supporting block 1361 is further configured to abut against an end of the main control board 121 adjacent to the through hole 112. With such a configuration, the first supporting block 1361 and the supporting boss 131 form a supporting line. In particular, the first supporting block 1361 and the two supporting bosses 131 together form a supporting plane, which can not only restrict the motor bracket 130 from pivoting toward the pressing region 113, but also limit the amount of deformation of the inadvertent-press region 114, thereby further preventing false triggering of the input button 1211. In addition, the first supporting block 1361 can limit the movement of the main control board 121 in the axial direction of the motor bracket 130.

Still referring to FIG. 11, the supporting structure 136 further includes two second supporting blocks 1362. The two second supporting blocks 1362 are disposed on the outer peripheral wall of the motor bracket 130 facing the pressing region 113. The two second supporting blocks 1362 are located on two sides of the main control board 121 in the circumferential direction of the motor bracket 130. The two second supporting blocks 1362 are both configured to abut against the portion of the housing 110 located between the through hole 112 and the inadvertent-press region 114, and the two second supporting blocks 1362 are both configured to limit movement of the main control board 121 in the circumferential direction of the motor bracket 130. With such a configuration, the end of the motor bracket 130 adjacent to the through hole 112 can be limited by one first supporting block 1361 and two second supporting blocks 1362. Further, with multiple supporting positions, the end of the motor bracket 130 adjacent to the through hole 112 is held more stably in place.

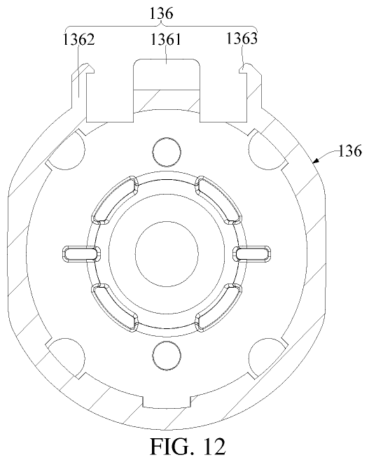

Further, referring to FIG. 12, the motor bracket 130 is provided with a mounting flat surface 137 on the outer peripheral wall of the motor bracket 130 opposite to the pressing region 113. The mounting flat surface 137 extends in the axial direction of the motor bracket 130, and the mounting flat surface 137 is configured to abut against the main control board 121. With such a configuration, the contact area between the motor bracket 130 and the main control board 121 is increased, so that the motor bracket 130 can support the main control board 121 more stably. Moreover, for each of the two second supporting blocks 1362, the second supporting block 1362 is provided with a retaining hook portion 1363 at an end of the second supporting block 1362 away from the motor bracket 130, and the retaining hook portion 1363 limits the main control board 121 in a radial direction of the motor bracket 130, thereby preventing the main control board 121 from disengaging from the mounting flat surface 137. With such a configuration, the main control board 121 can be directly fixed on the motor bracket 130, thereby facilitating the assembly of the motor bracket 130 and the main control board 121.

The present disclosure further provides a handheld appliance, which may be an electric toothbrush, an electric shaver, etc. The handheld appliance includes a head and the body structure 100 of the handheld appliance. The head is mated with the body structure 100 of the handheld appliance. For the specific structure of the body structure 100 of the handheld appliance, reference can be made to the above embodiments. Since the handheld appliance adopts all the technical solutions of all the above embodiments, the handheld appliance has all the beneficial effects brought by the technical solutions of the above embodiments, which will not be repeated here.

Finally, it may be noted that the above embodiments are only used to illustrate the technical solutions of the disclosure, but not to limit the disclosure. Although the disclosure has been described in detail with reference to the foregoing embodiments, a person of ordinary skill in the art may understand that modifications can still be made to the technical solutions described in the foregoing embodiments, or equivalent replacements can be made to some of the technical features thereof. These modifications or replacements do not cause the essence of the corresponding technical solutions to depart from the spirit and scope of the technical solutions of the embodiments of the disclosure.

What is claimed is:

1. A body structure of a handheld appliance, comprising a housing, an input assembly, and a motor bracket; wherein
the housing has a cylindrical shape and defines a mounting cavity, the housing is provided with a through hole at one end of the housing, the through hole is in communication with the mounting cavity, the housing is provided with a pressing region and an inadvertent-press region on an outer peripheral wall of the housing adjacent to the through hole, and the inadvertent-press region is located around the pressing region;
the input assembly comprises a main control board and a flexible pad that are both mounted in the mounting cavity, wherein the main control board is provided with an input button at a position opposite to the pressing region, and the flexible pad is mounted between the pressing region and the input button; and
the motor bracket is disposed in the mounting cavity, the motor bracket abuts against a side of the main control board facing away from the flexible pad, the motor bracket is provided with a supporting boss at a position opposite to the inadvertent-press region, and the supporting boss is configured to support the inadvertent-press region.

2. The body structure of the handheld appliance according to claim 1, wherein the supporting boss is implemented as at least two supporting bosses, and the at least two supporting bosses are respectively disposed on two opposite sides of the main control board in a circumferential direction of the motor bracket.

3. The body structure of the handheld appliance according to claim 1, wherein the supporting boss extends in an axial direction of the motor bracket, the supporting boss is provided with two first ribs on a side of the supporting boss adjacent to the main control board, the supporting boss is provided with two second ribs on a side of the supporting boss facing away from the main control board, the two first ribs are spaced apart from each other in the axial direction of the motor bracket, and the two second ribs are spaced apart from each other in the axial direction of the motor bracket.

4. The body structure of the handheld appliance according to claim 3, wherein the two first ribs are connected to each other by a third rib, and the third rib is fixedly connected to the motor bracket; and/or,
the two second ribs are connected to each other by a fourth rib, and the fourth rib is fixedly connected to the motor bracket.

5. The body structure of the handheld appliance according to claim 1, wherein the mounting cavity is provided with two fitting grooves on a cavity wall of the mounting cavity, the two fitting grooves both extend in an axial direction of the housing, the two fitting grooves are respectively disposed on two sides of the inadvertent-press region in a circumferential direction of the housing, the motor bracket is provided with two fitting ribs on an outer peripheral wall of the motor bracket, and each of the two fitting ribs has an interference fit with a corresponding fitting groove.

6. The body structure of the handheld appliance according to claim 5, wherein an orthographic projection of each of the two fitting ribs in a direction in which the input assembly faces toward the housing at least partially overlaps with the pressing region.

7. The body structure of the handheld appliance according to claim 5, wherein a central angle subtended by each of the two fitting grooves is equal to a central angle subtended by the pressing region, and openings of the two fitting grooves are disposed opposite to each other.

8. The body structure of the handheld appliance according to claim 5, wherein each of the two fitting ribs comprises at least two fitting segments and at least one connecting segment, each two adjacent fitting segments are connected by one connecting segment, the at least two fitting segments each have an interference fit with a corresponding fitting groove, and the at least one connecting segment has a clearance fit with a corresponding fitting groove.

9. The body structure of the handheld appliance according to claim 8, wherein in the at least two fitting segments, a fitting segment adjacent to the through hole is configured to be wedge-shaped.

10. The body structure of the handheld appliance according to claim 5, wherein the motor bracket is further provided with a supporting structure on an outer peripheral wall of the motor bracket facing the pressing region, the supporting structure and the supporting boss are spaced apart from each other in the axial direction of the motor bracket, and the supporting structure is configured to abut against a portion of the housing located between the through hole and the inadvertent-press region.

11. The body structure of the handheld appliance according to claim 10, wherein the supporting structure comprises a first supporting block, the first supporting block is disposed on the outer peripheral wall of the motor bracket facing the pressing region, the first supporting block extends in a circumferential direction of the motor bracket, the first supporting block is configured to abut against the portion of the housing located between the through hole and the inadvertent-press region, and the first supporting block is further configured to abut against an end of the main control board adjacent to the through hole.

12. The body structure of the handheld appliance according to claim 11, wherein the supporting structure further comprises two second supporting blocks, the two second supporting blocks are disposed on the outer peripheral wall of the motor bracket facing the pressing region, the two second supporting blocks are located on two sides of the main control board in the circumferential direction of the motor bracket, the two second supporting blocks are both configured to abut against the portion of the housing located between the through hole and the inadvertent-press region, and the two second supporting blocks are both configured to limit movement of the main control board in the circumferential direction of the motor bracket.

13. The body structure of the handheld appliance according to claim 12, wherein the motor bracket is provided with a mounting flat surface on the outer peripheral wall of the motor bracket opposite to the pressing region, the mounting flat surface extends in the axial direction of the motor bracket, and the mounting flat surface abuts against the main control board;
for each of the two second supporting blocks, the second supporting block is provided with a retaining hook portion at an end of the second supporting block away from the motor bracket, and the retaining hook portion on the second supporting block is configured to limit movement of the main control board so as to restrict displacement of the main control board in a direction toward the pressing region.

14. The body structure of the handheld appliance according to claim 1, wherein flexible pad is compressively disposed between the pressing region and the input key, such that the flexible pad elastically abuts against both the pressing region and the input key.

15. A handheld appliance, comprising a head and a body structure of the handheld appliance, wherein the head is mated with the body structure of the handheld appliance; wherein the body structure of the handheld appliance comprises a housing, an input assembly, and a motor bracket; wherein
the housing has a cylindrical shape and defines a mounting cavity, the housing is provided with a through hole at one end of the housing, the through hole is in communication with the mounting cavity, the housing is provided with a pressing region and an inadvertent-press region on an outer peripheral wall of the housing adjacent to the through hole, and the inadvertent-press region is located around the pressing region;
the input assembly comprises a main control board and a flexible pad that are both mounted in the mounting cavity, wherein the main control board is provided with an input button at a position opposite to the pressing region, and the flexible pad is mounted between the pressing region and the input button; and
the motor bracket is disposed in the mounting cavity, the motor bracket abuts against a side of the main control board facing away from the flexible pad, the motor bracket is provided with a supporting boss at a position opposite to the inadvertent-press region, and the supporting boss is configured to support the inadvertent-press region.

16. The handheld appliance according to claim 15, wherein the supporting boss is implemented as at least two supporting bosses, and the at least two supporting bosses are respectively disposed on two opposite sides of the main control board in a circumferential direction of the motor bracket.

17. The handheld appliance according to claim 15, wherein the supporting boss extends in an axial direction of the motor bracket, the supporting boss is provided with two first ribs on a side of the supporting boss adjacent to the main control board, the supporting boss is provided with two second ribs on a side of the supporting boss facing away from the main control board, the two first ribs are spaced apart from each other in the axial direction of the motor bracket, and the two second ribs are spaced apart from each other in the axial direction of the motor bracket.

18. The handheld appliance according to claim 17, wherein the two first ribs are connected to each other by a third rib, and the third rib is fixedly connected to the motor bracket; and/or,
the two second ribs are connected to each other by a fourth rib, and the fourth rib is fixedly connected to the motor bracket.

19. The handheld appliance according to claim 15, wherein the mounting cavity is provided with two fitting grooves on a cavity wall of the mounting cavity, the two fitting grooves both extend in an axial direction of the housing, the two fitting grooves are respectively disposed on two sides of the inadvertent-press region in a circumferential direction of the housing, the motor bracket is provided with two fitting ribs on an outer peripheral wall of the motor bracket, and each of the two fitting ribs has an interference fit with a corresponding fitting groove.

20. The handheld appliance according to claim 19, wherein an orthographic projection of each of the two fitting ribs in a direction in which the input assembly faces toward the housing at least partially overlaps with the pressing region.
